(19) United States
(12) Patent Application Publication
(10) Pub. No.: US 2004/0242033 A1
(43) Pub. Date: Dec. 2, 2004

(54) Contact with strengthened rib

(76) Inventor: Snower Hu, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/816,713

(22) Filed: Apr. 1, 2004

(30) Foreign Application Priority Data
May 30, 2003 (TW) 92210062

(51) Int. Cl. H01R 12/00

(52) U.S. Cl. 439/82

(57) ABSTRACT

A contact (10) for insertion into a hole (21) of a circuit board (20) comprises a top section (11), a pin-like section (13), and a compliant section (12) connecting the top section and the pin-like section. The compliant section is inserted into the hole of the circuit, and comprises a pair of beams (120,121). The compliant section defines a lognitudinal axis (126), a pair of slots (122) therethrough extending along the axis, and a rib (123). The beams surround the slots and the rib. The rib is located between the beams and extends along the axis. The rib reinforces a structure of the compliant section, result in that pin-like section remain straight in assembly or after use.

### BACKGROUND OF THE INVENTION

1. Field Of the Invention

The present invention relates to a contact, and particularly to an electrical contact having a compliant section with a strengthened rib.

2. Description of Prior Art

An electrical contact is widely used for insertion into a circuit board and an electrical connector. The contact usually comprises a pin-like section which is inserted into an electrical connector, a complicant section and a top section. The compliant section is inserted into a through hole of a circuit board. U.S. Pat. Nos. 5,564,954, 5,944,538, 4,534,611, 6,565,392 and 4,737,114 disclose this kind of conventional electrical contact.

FIG. 4 shows a conventional electrical contact 30. The contact 30 comprises a top section 31, a compliant section 32, and a pin-like section 33. The compliant section 32 can be inserted into a plated through hole 41 of a circuit board 40. The compliant section 32 comprises a slot 322 extending along a logitudinal direction and deviding the compliant section 32 into a pair of laterally spaced first and second beams 321, 323. A width of the compliant section 32 of the contact 30 is slightly greater than a diameter of the hole 41 of the circuit board 40. The hole 41 of the circuit board 40 has a first and second inside walls 410, 412. When the contact 30 is pressed to the the hole 41 of the circuit board 40, the first inside wall 410 of the hole 41 will extert force P₁′ on the first beam 321 of the compliant section 32 and the second inside wall 412 of the hole 41 will extert force P₂′ on the second beam 323 of the compliant section 32. Thus, the compliant section 32 of the contact 30 is stably fixed in the hole 41 of the circuit board 40.

If the force P₁′ is not equal to the force P₂′, there is tendency for some or all of the pin-like section 33 to tip at an angle as illustralled in FIG. 4. Because of the tight spacing between the adjacent contacts 30, it is very important that the pin-like sections 33 of the contacts 30 remain straight without tipping in order to be inserted into an electrical connector (not shown). When this happens, the pin-like section 33 is crushed and of cource no signal can be carried by the pin-like section 33.

An electrical contact that overcomes the above-mentioned problems is desired.

### SUMMARY OF THE INVENTION

Accordingly, an object of the present invention is to provide an electrical contact having a strengthened rib which reinforces a structure of the contact.

In order to achieve the above object, an electrical contact for insertion into a hole of a circuit board in accordance with a preferred embodiment of the present invention comprises a top section, a pin-like section, and a compliant section connecting the top section and the pin-like section. The compliant section is inserted into the hole of the circuit, and comprises a pair of beams. The compliant section defines a lognitudinal axis, a pair of slots therethrough extending along the axis, and a strengthened rib. The beams surround the slots and the rib. The rib is located between the beams and extends along the axis. The rib reinforced a structure of the compliant section, result in that the pin-like section remains straight in assembly or after use.

Other objects, advantages and novel features of the present invention will become more apparent from the following detailed description when taken in conjunction with the accompanying drawings, in which:

### BRIEF DESCRIPTION OF THE DRAWINGS

FIG. 1 is an enlarged, isometric view of an electrical contact in accordance with the preferred embodiment of the present invention;

FIG. 2 is a cross-setional view of the contact of FIG. 1 pressed into a hole of a circuit board;

FIG. 3 is a cross-sectional view taken along line III-III of FIG. 2; and

FIG. 4 is a cross-sectional view of a conventional electrical contact pressed into a hole of a circuit board.

### DESCRIPTION OF THE PREFERRED EMBODIMENT

Reference will now be made to the drawings to describe the present invention in detail.

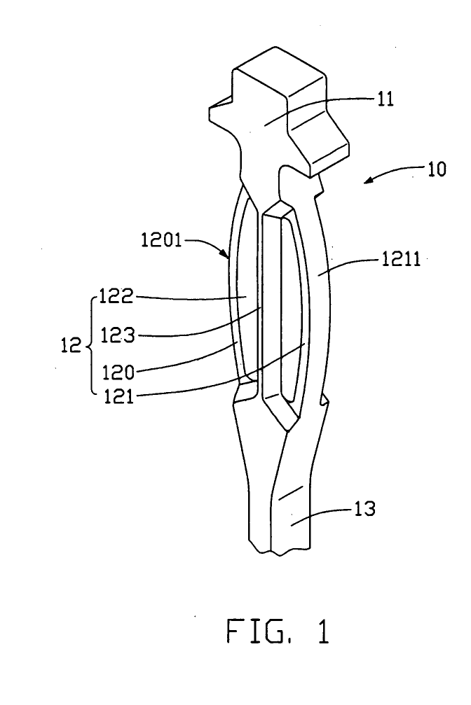

FIG. 1 shows an electrical contact 10 in accordance with the preferred embodiment of the present invention. The contact 10 is used for connecting a circuit board 20 and an electrical connector (not shown). The contact 10 comprises a top section 11, a pin-like section 13, and a compliant section 12 connecting the top section 11 and the pin-like section 13.

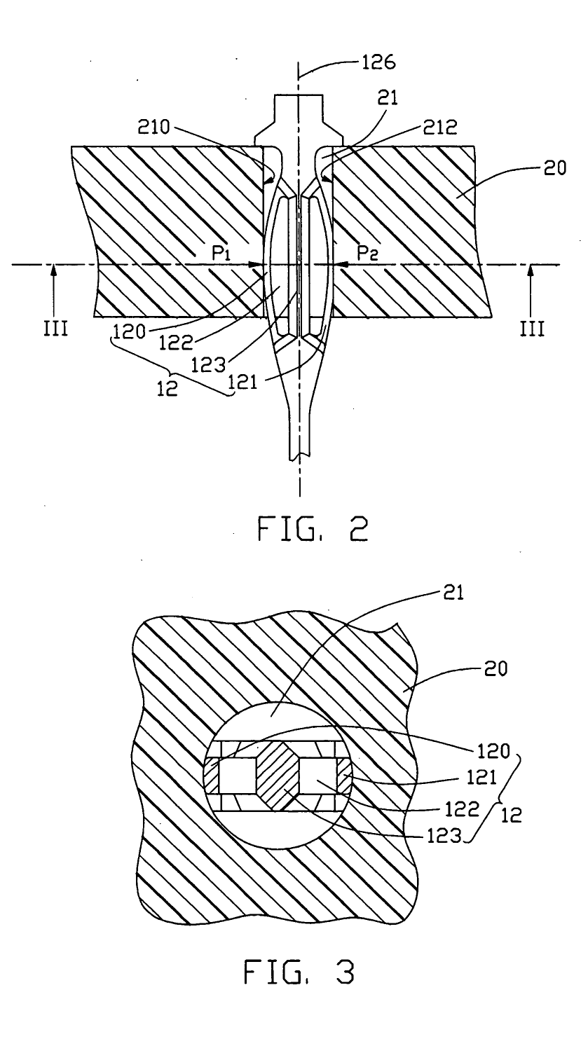

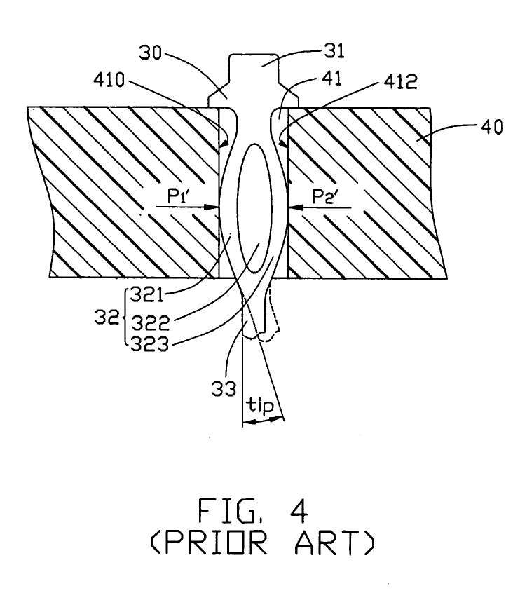

Referring also to FIGS. 2 and 3, the compliant section 12 is used for press fit insertion into a metal plated through hole 21 of the circuit board 20. The hole 21 of the circuit board 20 has a first and second inside walls 210, 212. The compliant section 12 defines an axis 126 along a lognitudinal direction, and a pair of needle eye-like separate slots 122 formed therethrough thereby forming a strengthened rib 123. The slots 122 extend along the axis 126, and are symmetrical about the rib 123. The rib 123 is located between the slots 122, and extends along the axis 126. The compliant section 12 comprises a pair of laterally spaced beams defined first beam 120 and second beam 121. The first and second beams 120, 121 surround the slots 122 and the rib 123. The first beam 120 has a first outer surface 1201, and the second beam 121 has a second outer surface 1211. A width between the first and second outer surfaces 1201, 1211 at respective widest point is slightly greater than a diameter of the hole 21 of the circuit board 20. The first and second outer surfaces 1201, 1211 are convex. A curvature radius of the first outer surface 1201 is general equal to a curvature radius of the first inside wall 210, and a curvature radius of the second outer surface 1211 is general equal to a curvature radius of the second inside wall 212. Thus, when the compliant section 12 is inserted into the hole 21 of the circuit board 20, the first and second outer surfaces 1201, 1211 of the compliant section 12 can entirely engage with the first and second inside walls 210, 212, respectively, result in that the compliant section 12 of the contact 10 is stably fixed in the hole 21 of the circuit board 20. In addition, respective thickness of the first and second beams 120, 121 is smaller than a thickness of the rib 123. Accordingly, the first and second beams 120, 121 have good resilient, and it is easy for the compliant section 12 to be inserted into the hole 21 of the circuit board 20. Simultaneously, the rib has a reinforced structure.

In assembly, the compliant section 12 is inserted into the hole 21 of the circuit board 20, and the pin-like section 13 is fixed the electrical connector. The first inside wall 210 of the hole 21 of the circuit board 20 exerts force P₁ on the first beam 120 of the contact 10, and the second inside wall 212 of the hole 21 of the circuit board 20 exerts force P₂ on the second beam 121 of the contact 10. Beacuae the rib 123 has a reinfored structure, the compliant section 12 has a reinforced structure. If the force P₁ is not equal to the force P₂, the axis 126 of the compliant section 12 remains straight in assembly or after use. Therefore, the pin-like section 13 remains straight without tipping in assembly or after use. This insures reliable electrical connection of the circuit board 20 and the electrical connector.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. A contact comprising:
a compliant section defining a lognitudinal axis, a plurality of slots, and at least one rib, and comprising a pair of beams surrounding the slots and the at least one rib, the slots extending along the axis, the at least one rib being located between two adjacent slots; and
a first section joined to the compliant section.

2. The contact as described in claim 1, further comprising a second section, the compliant section connecting the second section and the first section.

3. The contact as described in claim 1, wherein the compliant section comprises a pair of slots and a rib, the slots being symmetric about the rib.

4. The contact as described in claim 3, wherein the rib extends along the axis.

5. The contact as described in claim 4, wherein a thickness of the rib is greater than a thickness of each of the beams.

6. The contact as described in claim 5, wherein each of the beams has a convex outer surface.

7. A stamped contact part for use within an electrical connector, comprising:
a compliant section defining a longitudinal direction and including:
a pair of slots spaced by a rib and extending along said longitudinal direction and through said compliant sections in a thickness direction of said compliant section which is perpendicular to said longitudinal direction, each of said slots being located between said rib and one corresponding outer arc-like beam in a transverse direction which is perpendicular to both said longitudinal direction and said thickness direction; wherein
a dimension of said rib along said thickness is larger than that of said arc-like beam along said thickness direction.

8. The contact part as described in claim 7, wherein said dimension of the rib is substantially equal to a thickness of a remainder of said contact part.
